(19) United States
(12) Patent Application Publication
(10) Pub. No.: US 2010/0011111 A1
(43) Pub. Date: Jan. 14, 2010

(54) METHOD FOR OFFERING A CALL CENTER SERVICE IN A PEER-TO-PEER NETWORK

(75) Inventor: Mohammad Vizaei, Wien (AT)

Correspondence Address: LERNER GREENBERG STEMER LLP, P O BOX 2480, HOLLYWOOD, FL, 33022-2480, US

(73) Assignee: NOKIA SIEMENS NETWORKS GMBH & CO. KG, München (DE)

(21) Appl. No.: 12/438,455

(22) PCT Filed: Jul. 18, 2007
(86) PCT No.: PCT/EP07/57418

§ 371 Date: Mar. 18, 2009

(30) Foreign Application Priority Data
Aug. 21, 2006 (DE) 10 2006 039 170.5

(51) Int. Cl. G06F 15/16; H04L 12/66

(52) U.S. Cl. 709/228; 370/352

(57) ABSTRACT

A call center service is offered in a peer-to-peer network. At least one peer in the peer-to-peer network has a call center function added to it, and a check is then carried out by way of a search algorithm to determine whether a called subscriber is or is not registered in the peer-to-peer network. If the called subscriber is registered, an IP address is first of all determined for that subscriber, and a check is then carried out to determine whether the call center service has been activated for this subscriber. An incoming call is then diverted to a peer with a call center function, and is not passed on to the called subscriber until contact is made with the peer with the call center function. Otherwise, if the subscriber is not registered in the peer-to-peer network, further entries for the called subscriber are first of all checked in the peer-to-peer network. If there is an entry for an active call center service, an address of a peer with a call center function is sought, and the incoming call is then forwarded directly to that peer with the call center function.

### TECHNICAL FIELD

The invention relates to a method for offering a call center service in a peer-to-peer network.

### PRIOR ART

The expression peer-to-peer, P2P or P-to-P for short, normally means a relationship with equal authority between units, for example computers, which are involved in a communication and are used for communication by subscribers. Peer-to-peer can therefore also be regarded as an expression which is synonymous to communication between equal parties. A unit which is involved in the communication, for example a computer or that subscriber which is using this computer, is referred to as a peer.

Peer-to-peer networks are therefore networks without central access monitoring in which, for example, all the computers have equal authority, and all the subscribers act with equal authority. In a peer-to-peer network, each unit (for example a computer etc.) can thus not only make use of services but can also make them available to other subscribers. The units or computers can in this case be used by the subscribers as workstations, or else can carry out tasks in the network.

The opposite of a peer-to-peer principle is the so-called client-server system in which, on the one hand, there is a so-called server which offers services, and on the other hand there are so-called clients which use the offered services. In the peer-to-peer network, this role distribution for the subscribing units (for example computers) is cancelled. In contrast to a client-server system, a link exists directly between the computers of two subscribers, without the interposition of a network server, in a peer-to-peer network.

Dispensing with central servers leads to a reduction in the data traffic in the network, making it possible to store large amounts of data locally, and increasing the reliability of the network, in a simple manner. Peer-to-peer networks have the disadvantages not only of the stringent requirements for the performance of the units involved (for example computers etc.) but often also the low level of security since accesses to the communication based on a peer-to-peer network can be controlled and monitored only with difficulty, owing to the lack of central management.

Peer-to-peer networks can be used for various purposes. In particular, they are used to interchange information and/or data such as exchange markets for music or video files, games, etc. However, peer-to-peer networks are also used for services such as instant messaging, in which subscribers can communicate (chat) with other subscribers by means of short text messages in real time. Furthermore, peer-to-peer networks are also used for so-called grid computing—as used, for example, happily in biotechnological or computer technology organizations. Grid computing can also be referred to as “distributed data processing” in which unused CPU performance and/or free memory space of other computers in the peer-to-peer network is used when computer processes require intensive computer power.

Recently, peer-to-peer networks have also been used for so-called IP telephony or voice-over-IP, in which case this means making telephone calls via a communication network based on the Internet standards. In this case, it is possible to make calls from one computer to another in the peer-to-peer network, in which case this could be carried out in routers, for example independently of servers, for example so-called proxy servers or security programs such as so-called firewalls. When information or services are interchanged or when using voice-over-IP, the peer-to-peer network forms a so-called “closed” communication network. This means that the services such as voice-over-IP etc. can be used only by currently active subscribers in the peer-to-peer network. A subscriber is regarded as being active when it is registered in the peer-to-peer network. Each subscriber in the peer-to-peer network is in this case allocated so-called resources, for example an IP address, e-mail address or other information such as statements which indicate what services or performance features of the peer-to-peer network are being used and/or have been activated by the subscriber. By way of example, these resources can also be combined in a so-called user profile.

In the case of the resources, a distinction can in this case be drawn between so-called dynamic and so-called static resources. Dynamic resources are available only when the subscriber is also actually registered in the peer-to-peer network. One such dynamic resource is, for example, the IP address via which the computer of a subscriber or the peer can be addressed. Static resources, for example the e-mail address of a subscriber, are always available for the peer-to-peer network, even when the subscriber is not registered or his computer is switched off.

Peer-to-peer networks are particularly highly suitable for a so-called home network, for most relatively small company networks or applications in the business field. In this case, peer-to-peer networks offer advantages such as low costs, since the tasks of the network are distributed among a plurality of computers and no additional hardware is therefore required; low license costs, for example because no—generally expensive—server licenses are required or simple installation, since the setting up as well as the upgrading of a peer-to-peer network is relatively simple and does not require any specific knowledge about a network operating system.

Peer-to-peer networks can be used not only for interchanging information and/or data in the form of files or “distributed data processing (grid computing)” but also for IP telephony and voice-over-IP. Particularly when used as a company network, it is therefore of interest for a function of a telephone center or a call center to also be made available, for example as a call center service, in the peer-to-peer network, for example as is offered by conventional telephone systems (for example private branch exchange systems, PABX, Centerx, etc.).

A telephone system is a switching device by means of which a plurality of terminals—so-called exchanges (for example a telephone set, fax unit, etc.)—are connected not only to one another but also to a public telephone network. A telephone system is normally based on a central computation unit which manages the connected exchanges and carries out the switching function for the calls. This central computation unit also carries out functions such as the telephone center or the call center service.

Calls can be managed and passed on from the telephone center. In this case, in conjunction with a telephone system, one or more specific terminals and specific upgrades to the telephone system, for example a routing system, are normally referred to as a telephone center or call center. The routing system ensures that incoming calls to the telephone center are first of all passed to a so-called operator, from which the call is then passed on to the desired subscriber. A call from the routing system to the telephone center is normally passed to an operator when, for example, the caller has dialed a so-called main call number of the telephone system or when, for example, the called subscriber is unavailable (for example the subscriber is busy, does not answer, or has placed a diversion to the call center).

A so-called queue function is frequently coupled to a telephone center. In this case, a call is placed in a queue instead of refusing this call when, for example, all the operators in the telephone center are currently busy with calls. When an operator becomes free, the call is then connected to this operator. During the waiting time, the call can be held on the line, for example by playing an announcement or an audio tape.

The call center services and telephone center functionalities which are offered nowadays are normally provided by means of telephone systems. Conventional telephone systems are in this case based on a central computation unit which centrally manages the exchanges or terminals such as clients in the case of a client-server system. Functions and systems such as the routing system or the queue function are available centrally.

Since, however, all the computers and computation units in a peer-to-peer network have equal authority and no central server or computation units are normally provided, for example for management purposes, no solution is currently known for a call center service in a peer-to-peer network.

### DESCRIPTION OF THE INVENTION

The present invention is therefore based on the object of offering a method by means of which a call center service can be offered for subscribers in a peer-to-peer network.

This object is achieved by a method for offering a call center service in a peer-to-peer network, in which at least one peer in the peer-to-peer network has a call center functionality added to it, and a search algorithm is then used to check whether a called subscriber is or is not registered in the peer-to-peer network. In the situation in which the called subscriber is registered, an IP address of the subscriber is first of all determined, and it is then determined whether the call center service has been activated for this subscriber. An incoming call is then diverted to the peer with the call center function. The incoming call is passed on to the called subscriber only after a contact with the peer with the call center function. In the other case, in which the subscriber is not registered in the peer-to-peer network, further entries of the called subscriber are first of all checked in the peer-to-peer network. In the event of an entry for an active call center service, an address of a peer with the call center function is searched for, and the incoming call is then passed on directly to this peer with the call center function.

The main aspect of the solution proposed according to the invention is that the subscribers can be offered a call center service in the peer-to-peer network, in which case it is possible to use already existing computers and systems—that is to say the available peers. In this case, there is no need for often costly inclusion of additional devices (for example central server, etc.) as must be operated by a provider of a call center service. The only peers which are upgraded in a simple manner in the network are those which are intended to carry out a call center function. In this case, by way of example, the call center function may be in the form of a somewhat upgraded client program. From the point of view of the peer-to-peer network, a peer with a call center function is, however, still considered to be a “normal” peer. The resources which are available in the peer-to-peer network (for example IP address, e-mail address, etc.) of the subscribers and/or database and peer-to-peer software such as the search algorithm for the call center service can also advantageously be used—possibly in a slightly modified form (for example an entry as to whether a specific peer is or is not using the call center service in the resources of a subscriber). By way of example, a routing function for the call center service is then carried out by the search algorithm.

It is advantageous if a call which is passed on from a peer with the call center function to a called subscriber is provided with a special identification in the signaling. The peer of the called subscriber thus recognizes that the incoming call has already been passed on from a peer with the call center function. This avoids so-called “endless loops”.

In one preferred development of the invention, a peer with the call center function is allocated to that subscriber in the peer-to-peer network which is using the call center service. This allows the search algorithm to determine to which peer with the call center function a call should be passed on, in a simple manner and using the already existing resources. The resources of the subscriber in this case easily have at least one entry added to them, which records whether the call center service has been activated for this subscriber or this peer, and to which peer with the call center service the call should be passed on. By way of example, the IP address of the peer with the call center function can be used for passing on the call.

It is normally unnecessary for each peer to have a call center function in order to carry out the call center service. It is sufficient for at least one peer or else a plurality of peers in the network to have the call center function. It is therefore worthwhile and advantageous if a plurality of subscribers or peers without the call center function can be allocated to one peer with the call center function.

It is also advantageous, in the situation in which a peer with the call center function is unavailable, for an incoming call to be held by playing local announcements because this makes it possible to offer a queue function, in a simple manner, for the call center service in the peer-to-peer network. The announcements for holding the incoming call are in this case stored locally in the computer of the peer with the call center function. When the peer with the call center function becomes available again, then the call can be accepted and processed in a simple manner.

In order to achieve the object it is recommended that the peer with the call center function checks a status of the called subscriber from the entries of the called subscriber in the peer-to-peer network. By way of example, this makes it possible to signal in a simple manner to the caller whether the called subscriber is or is not currently available in the peer-to-peer network. By way of example, functions such as “buddy list” are available for checking the subscriber status in the peer-to-peer network. “Buddy lists” such as these are already used, for example, for the “instant messaging” service. A “buddy list” is in this case a type of contact list in which addresses of other subscribers can be stored. Furthermore, however, the “buddy list” also provides an indication of the current status (for example “online”, “not available”, “absent”, “offline”, etc.) of a subscriber in the network.

It is also advantageous for the so-called session initiation protocol SIP to be provided for signaling since SIP represents a signaling protocol for voice-over-IP and IP telephony, which has been defined by a plurality of so-called requests for comments RFCs, such as RFC 3261, by the Internet Engineering Task Force IETF.

### BRIEF DESCRIPTION OF THE DRAWING

The invention will be explained in more detail in the following text with reference to two figures which show, in an exemplary manner, the procedure in the method according to the invention for offering a call center service in a schematically illustrated peer-to-peer network. In this case, by way of example,

FIG. 1 illustrates the procedure for the method in the situation in which a called subscriber is registered.

FIG. 2 shows, schematically, the procedure for the method according to the invention when the called subscriber is not registered in the peer-to-peer network.

### IMPLEMENTATION OF THE INVENTION

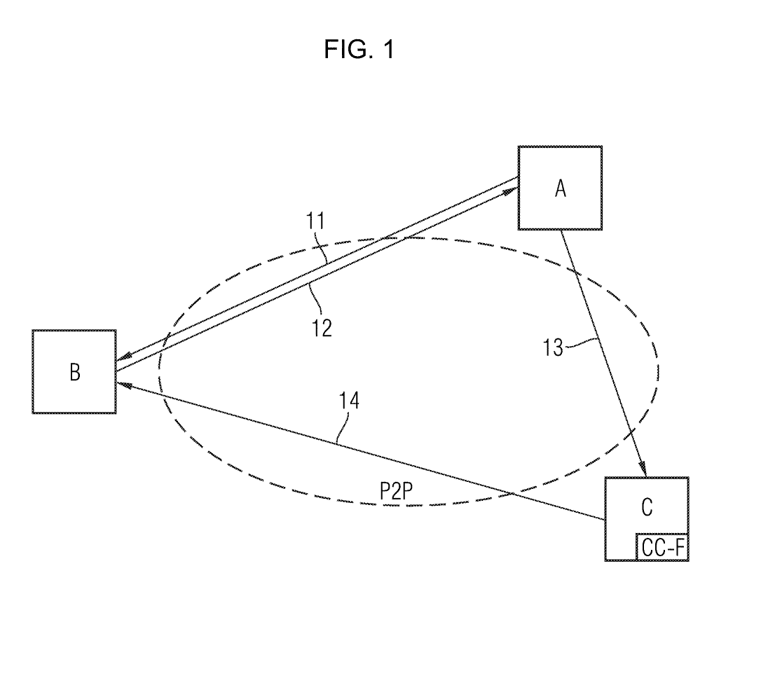

FIG. 1 schematically illustrates a peer-to-peer network P2P which, by way of example, comprises a first peer A, a second peer B and a third peer C. In the present example, a second subscriber, to which the second peer B is allocated, is called by means of IP telephony in the peer-to-peer network P2P by a first subscriber, which uses the first peer A. Thus, in consequence, the first subscriber in the peer-to-peer network P2P is also referred to as the caller, and the second subscriber is also referred to as the called subscriber. The peer C in the peer-to-peer network P2P has had a call center function CC-F added to it and can thus be used as a call center for calls in the peer-to-peer network P2P.

In a first method step 11, a call is set up in the peer-to-peer network P2P and a search algorithm is in this case used to identify that the called subscriber or the peer B is registered in the peer-to-peer network P2P. An IP address of the peer B or of the called subscriber is therefore determined in the first method step 11. This IP address is then made available to the peer A or to the caller in order to set up the call.

For carrying out the search algorithm and for determination of the IP address from subscriber resources which are available in the peer-to-peer network P2P, it is irrelevant in the first method step 11 what specific structure of a peer-to-peer network P2P is used.

For example, if the peer-to-peer network P2P has a centralized (hybrid) architecture, in which information or data relating to the subscribers, such as subscriber resources or user profiles, is or are managed on one or more servers, the search algorithm can be run and the IP address of a subscriber can be determined only on this server or these servers.

In the case of a second category of peer-to-peer networks P2P, the decentralized (pure) peer-to-peer networks P2P, in which there is no centralized device, the search algorithm is carried out in the entire peer-to-peer network P2P in order to find out whether a specific subscriber/peer is or is not registered.

A third category of the architecture of peer-to-peer networks P2P—the so-called super-peer-to-peer networks—represents a mixed form of the two other network forms. In this architecture, so-called super-peers with connected “clients” form clusters, with the super-peer managing information and/or data (for example subscriber resources, etc.) of the connected “clients”. In this architecture, it is therefore worthwhile, in particular, for example, for the super-peers to be run through by the search algorithm in order to find out whether a specific subscriber/peer is or is not registered, or in order to determine its IP address, for example.

After an example of setting up a call to the called subscriber or the associated peer B in the first method step 11, in which it has been found that the called subscriber or peer B is registered in the peer-to-peer network P2P and its IP address is therefore available, a call is set up to the peer B. In this case, it is found in a second method step 12 that a call center service has been activated for the called subscriber or peer B. The IP address of the peer C with the call center function CC-F, which is allocated as a call center to the peer B, is thus signaled to the caller or the peer A. The call is then diverted to the peer C with the call center function CC-F.

In a third method step 13, the call is then passed to the peer C with the call center function CC-F or to the call center. In the situation in which, for example, the peer C or the call center is unavailable (for example the call center is busy), an announcement which is stored locally in the peer C, for example, can be played to the caller, with the call thus being held until the call center is available again. If the call center is immediately available, the call is accepted.

After a conversation with the personnel at the call center, the call is then passed on in a fourth method step 14 to the peer B or to the called subscriber. In this case, the call can be provided with a special identification in signaling which is provided, for example, with the aid of the session initiation protocol SIP. This special identification indicates that the call has already had contact with the peer C or the call center. This therefore avoids so-called endless loops for the call.

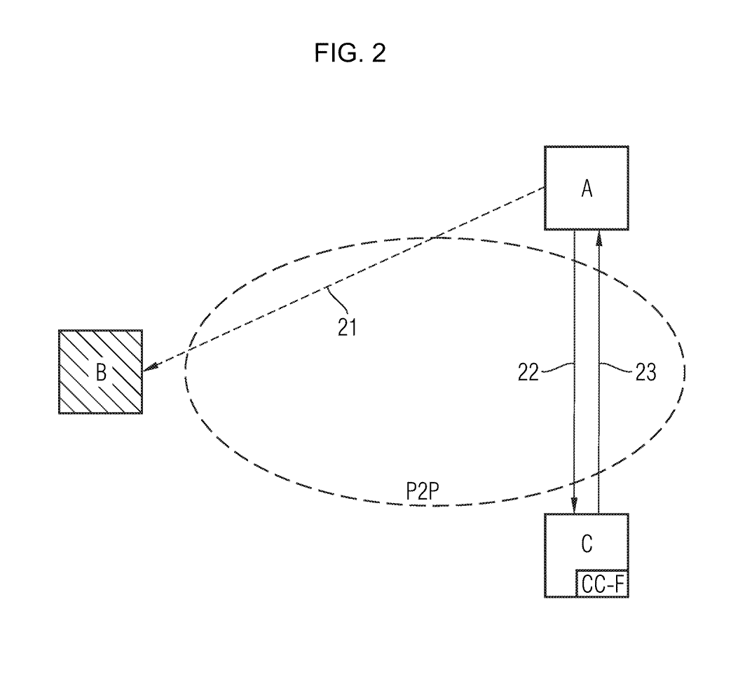

FIG. 2 schematically shows the procedure for the method according to the invention for the situation in which the called subscriber or the associated peer B is not registered or is not active in the peer-to-peer network P2P.

In this case, FIG. 2 once again illustrates the peer-to-peer network P2P schematically, comprising, by way of example, the peers A, B and C, with the peer B in this case not being registered in the peer-to-peer network. The peer C in the peer-to-peer network P2P has once again had the call center function CC-F added to it and it is thus used as a call center for calls in the peer-to-peer network P2P.

In a fifth method step 21, as in the case of the first method step 11, a caller uses its peer A to set up a call in the peer-to-peer network P2P to a called subscriber or to its peer B. In this case, however, the search algorithm finds that the called subscriber or the peer B is not registered in the peer-to-peer network P2P. In consequence, for example, no IP address is available in the peer-to-peer network, for passing on the call, for the peer B or for the called subscriber. However, in the case of this fifth method step 21, the search algorithm has found further information—so-called static subscriber resources—for the called subscriber or the peer B. On the basis of these static resources, it is found that the call center service has been activated for the called subscriber or the peer B. An address (for example IP address) of the peer C with the call center function CC-F can thus also be determined from the static resources, when this has been allocated to the called subscriber or to the peer B as a call center.

In order to carry out the search algorithm in the peer-to-peer network P2P and to determine the static subscriber resources in this fifth method step 21, it is irrelevant—as in the case of the first method step 11—which specific structure is used for the peer-to-peer network P2P.

In a sixth method step 22, the call is then passed on to the peer C with the call center function CC-F and is accepted by the call center associated with the peer C—provided, for example, that this is not busy. In this case, an announcement which is stored locally in the peer C can be played to the caller in order to hold the call until the call center is available again.

In a seventh method step 23, the call center or the peer C checks a status of the called subscriber and of the peer B in the peer-to-peer network P2P, which can be signaled to the caller. For example, a function such as the “buddy list” function can be used for the check of the status, and it is also used for services such as instant messaging. In this case, a “buddy list” is a type of contact list in which addresses of other subscribers can be stored. Furthermore, however, the “buddy list” also indicates what the current status (for example “online”, “not available”, “absent”, “offline”, etc.) of a subscriber in the network is. This status (for example “offline”, “absent”, etc.) can then be detected by the call center and can be signaled to the caller.

1-7. (canceled)

8. A method for offering a call center service in a peer-to-peer network, which comprises:
adding a call center function to at least one peer in the peer-to-peer network;
checking with a search algorithm whether or not a called subscriber is registered in the peer-to-peer network;
if the called subscriber is registered:
first determining an IP address of the subscriber;
subsequently determining whether or not the call center service has been activated for the subscriber;
diverting an incoming call to the peer with the call center function;
passing on the incoming call to the called subscriber only after a contact with the peer with the call center function;
if the called subscriber is not registered:
first checking further entries of the called subscriber in the peer-to-peer network;
in the event of an entry for an active call center service, searching for an address of the peer with the call center function; and
passing on the incoming call directly to the peer with the call center function.

9. The method according to claim 8, which comprises providing a call that is passed on from the peer with the call center function to a called subscriber with a special identification in the signaling.

10. The method according to claim 8, which comprises assigning a peer with the call center function to a subscriber in the peer-to-peer network that is using the call center service.

11. The method according to claim 10, which comprises assigning a plurality of subscribers in the peer-to-peer network to one peer with the call center function.

12. The method according to claim 8, which comprises, in a situation in which the peer with the call center function is unavailable in the peer-to-peer network, holding an incoming call by playing local announcements.

13. The method according to claim 8, wherein the peer with the call center function checks a status of called subscriber entries of the called subscriber in the peer-to-peer network.

14. The method according to claim 8, which comprises signaling with the session initiation protocol SIP.
